(19) United States
(12) Patent Application Publication
(10) Pub. No.: US 2010/0102598 A1
(43) Pub. Date: Apr. 29, 2010

(54) ELECTROMOTIVE DRIVE FOR A MOTOR VEHICLE ACTUATING PART AND DRIVE METHOD

(75) Inventors: Heiko Frey, Ditzingen (DE); Hubert Lamm, Kappelrodeck (DE); Christian Stolz, Buehl (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/528,046

(22) PCT Filed: Jan. 8, 2008
(86) PCT No.: PCT/EP2008/050125

§ 371 Date: Dec. 15, 2009

(30) Foreign Application Priority Data
Feb. 21, 2007 (DE) 10 2007 008 384.1

(51) Int. Cl. B60J 7/057; G05B 19/402

(52) U.S. Cl. 296/223; 318/672

(57) ABSTRACT

The invention relates to an electromotive drive (1) for a motor vehicle actuating part (2) which can be moved into at least one defined target position (16), said drive having a detection device (14) for detecting whether the motor vehicle actuating part (2) is in a tolerance range (19). The invention provides for the tolerance range (19) to be able to be determined on the basis of the stop position (18) of the motor vehicle actuating part (2).

### STATE OF THE ART

The invention relates to an electromotive drive according to the generic term of claim 1 as well as a procedure for controlling an electromotive drive for a motor vehicle actuator part according to the generic term of claim 11.

An electromotive drive for an actuator part of a motor vehicle is known from EP 0 878 338 B1, whereby the actuator part can be adjusted into a defined target position with the aid of the electromotive drive. A tolerance range is defined around the target position, whereby the target position as well as the upper and lower margins of the tolerance range are stored in a storage of a signal-processing arrangement of the electromotive drive as firm absolute variables. If the actuator part is located in the determined tolerance range the drive controls the actuator part independently until the actuator part reaches the target position. Because the approaching of the defined target position is strongly depending on the tolerance, in particular when the actuator part is a sunroof, due to external mechanic influences, the defined target position cannot be achieved for sure de facto. Moreover the actuator part reaches in most of the cases a stop position, which deviates from the determined target position.

If the described electromotive drive shall be used for a control task, at which it is a triggering condition that the actuator part is not located in the tolerance range anymore, it happens that in some control cases the triggering condition is fulfilled faster than in other triggering cases, because the actual stop position varies from the defined, which means determined target position and is sometimes even located in the marginal region of the tolerance range. If the stop position is located in the marginal region of the tolerance range, thus close to a fixed upper or lower threshold value of the tolerance range, timely short and/or intensity-weak mechanic external influences are sufficient to move the actuator part out of the tolerance range, whereby the triggering condition is achieved faster, as if the stop position would be located in the close proximity of the target position.

### DISCLOSURE OF THE INVENTION

### Technical Task

The invention is therefore based on the task to suggest an electromotive drive as well as a control procedure, with which it can be ensured that the requirements for fulfilling the triggering condition are always the same not depending on how big the deviation of the actual stop position from the target position is.

### Technical Solution

This task is solved by the characteristics of claim 1 regarding the electromotive drive and by the characteristics of claim 11 regarding the control procedure.

Advantageous improvements of the invention are stated in the sub-claims. All combinations of at least two of the characteristics that are stated in the description, the claims and/or figures fall in the range of the invention.

The invention is also based on the idea not to provide fixed absolute margins for the tolerance range (tolerance field) and not to store them in a storage of the electromotive drive, but to determine or calculate the tolerance range depending on the stop position, which means the actual position after the process of adjusting the motor vehicle actuator part. The stop position that has been determined preferably with the aid of the detection device creates therefore the basis for calculating the tolerance range after the adjusting process. In doing so it is ensured that the distance of the actuator part to the upper and lower threshold value of the tolerance range is always the same, independent of how far the stop position deviates from the pre-defined, in particular stored target position.

In order to improve the invention it is advantageously provided that the electromotive drive, in particular a signal-processing arrangement of the drive is construed in such a way that no new adjusting of the motor vehicle actuator part into the target position takes place, even if an operator makes such a determination in particular with the aid of a control switch, as long as the detection device detects that the motor vehicle actuator part is located in the tolerance range. The electromotive drive or the control procedure are very advantageous in particular for such a control task because a very short adjusting of the motor vehicle actuator part that is disturbing the operator is avoided within the tolerance range due to the dependency of the absolute margins of the tolerance range upon the actual stop position.

In a configuration of the invention the target position is only approached again if the motor vehicle actuator part moves out of the tolerance range and improves there in particular due to external influences, such as vibrations etc.. The adjusting of the motor vehicle actuator part can thereby take place automatically after leaving the tolerance range according to a first alternative, thus directly after detecting the leaving of the tolerance range or according to a second alternative only at a corresponding default of an operator. If the motor vehicle actuator part, in particular a sunroof leaves the tolerance range, the target position is (again) approached at the second alternative at a (new) adjusting commando to the defined target position. If on the other hand a adjusting commando takes place to the target position while the motor vehicle actuator part is located within the tolerance range, no new approaching of the target position takes place, because the roof is located within the tolerance range and therefore sufficiently close to the target position, whereby a very short adjusting movement of the motor vehicle actuator part that is disturbing the operator is avoided.

It is a particular advantage if the tolerance field can be parameterized, thus if different (relative) tolerance margins can be determined for different target positions or different application cases, in particular if they can be stored in a storage of the electromotive drive.

In order to improve the invention it is advantageously provided that the detection device comprises a rotation sensor, which preferably works together with the rotor shaft of the electromotor. The detection device is thereby preferably a part of a signal-processing arrangement. An embodiment is advantageous, at which at least one magnet field sensor with a magnetic partition that is can be rotated relatively to each other. The magnet ring is thereby preferably connected torque-proof with the rotor shaft of an electromotor of the drive and works in particular together with two hall-sensors for detecting the actual position and if necessary for detecting the adjusting direction. The actual stop position that has been determined by the detection device is then used as basis for determining the absolute tolerance range margins.

In particular at adjustable vehicle roof parts it is usual to provide two target positions for a nominal roof position, which are approached independent of the adjustable roof part, from the direction that the roof part is approaching the nominal position (opening and closing). If one would use those target position as basis for the tolerance range that vary from each other, or determine the tolerance range so that it would mandatorily comprise both target positions, the tolerance range, thus the range, in which the nominal position is reached, would be very big. Thereby that not the target positions are used as basis for determining the tolerance range, but the actual stop position is used, the tolerance range has also an optimal size, even if two target positions that are distanced from each other are pre-adjusted or defined for a nominal position.

As an improvement of the invention it is advantageously provided that the motor vehicle actuator part is an actuator part that can be adjusted between two end positions. The target position or at least one of the target positions is thereby preferably created by an end position.

The electromotive drive qualifies in particular for adjusting a motor vehicle actuator part that is construed as a vehicle roof part, preferably an adjustable roof part of a sunroof, a lifting roof, sliding roof or sun roller blinds. Especially vehicle roofs are exposed to high mechanic external influences, as vibrations. Due to those vibrations the adjustable roof part is very often moved from a position that has been approached once or from the tolerance range.

Subject matter of the invention is also a procedure for controlling an electromotive drive for a motor vehicle actuator part, in particular a vehicle roof part, at which the actual stop position of the motor vehicle actuator part after an adjusting process is used for calculating the absolute margins of the tolerance range.

The stop position creates the basis (calculation basis) for determining the tolerance range.

Every disclosed characteristic of the invention according to the device shall also be disclosed according to the procedure and vice versa.

### SHORT DESCRIPTION OF THE DRAWINGS

Further advantages, characteristics and details of the inventions arise from the subsequent description of preferred embodiments as well as from the drawings. They show in:

FIG. 1 an electromotive drive for adjusting a vehicle actuator part that is construed as vehicle roof part and

FIG. 2 an alternative embodiment with two target positions that are assigned to a nominal position.

### EMBODIMENTS OF THE INVENTION

The same components and components with the same function are tagged with the same reference signs in the figures.

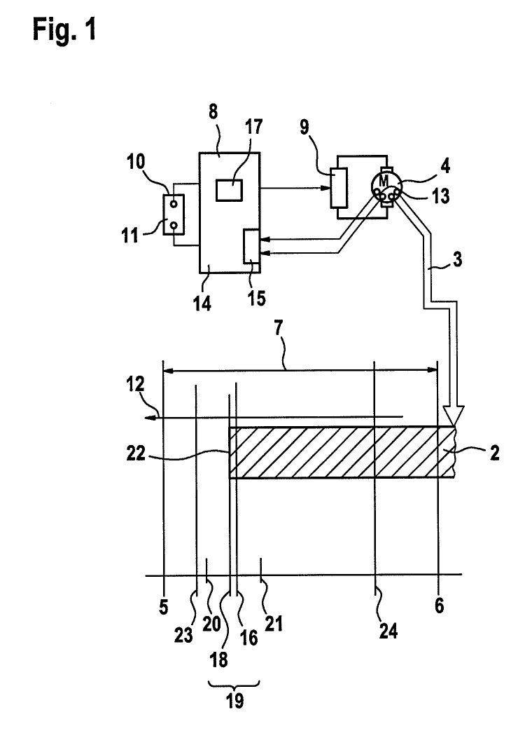

FIG. 1 shows an electromotive drive 1 for a motor vehicle actuator part 2 that is construed as sunroof. An arrow 3 symbolizes thereby the mechanic coupling of a driving motor 4 with the motor vehicle actuator part 2, in particular under interposing of a not shown gear unit.

With the aid of the driving motor 4 the motor vehicle actuator part 2 can be adjusted between two end positions 5, 6, whereby the arrow 7 indicates the maximum adjusting area. The drive 1 provides a signal-processing arrangement 8, which regulates or controls the drive by a motor excitation circuit 9. An operating unit 10 in the form of a toggle switch 11 that can be switched around a neutral center position in two directions transfers actuator commands of an operator to the signal-processing arrangement 8. One switch direction of the toggle switch 11 triggers a movement of the motor vehicle actuator part 2 in direction 12, thus in direction of the end position 6. A detection device 14 with two magnet field sensors 13, which are construed as hall sensors and which are arranged in the driving motor 4 of the drive 1 that is construed as electromotor is part of the signal-processing arrangement 8. The magnet field sensors 13 work together as rotor sensors with a magnet ring on the rotor shaft of the driving motor. Their sensor signals are evaluated by the detection device 14 or by the signal-processing arrangement 8 by an interface 15 for determining the engine speed, the rotational direction and other movement variables of the driving motor 4. From this data the detection device 14 or the signal-processing arrangement 8 determine the actual position of the motor vehicle actuator part 2, in particular the stop position 18, which means the actual position after adjusting the motor vehicle actuator part 2.

The electromotive drive 1 works as follows: an operator requests an adjusting of the motor vehicle actuator part 2 by operating the toggle switch 11. The signal-processing arrangement 8 actuates the driving motor 4 over the motor excitation circuit 9, for example based on end position 6 that is on the right side of the drawing in the direction of a first defined target position 16 (intermediate position). During the movement of the motor vehicle actuator part 2 the detection device 14 reads the hall sensor signals that are generated in the driving motor 4 over an interface 15 and determines from the incremental hall sensor signals the actual position of the actuator part. The aimed first target position 16, which illustrates a nominal position for the motor vehicle actuator part 2, is put down in charts in a storage 17 of the signal-processing arrangement 8. If the signal-processing arrangement 8 detects that the target position 16 is reached the driving motor 4 and thus the motor vehicle actuator part 2 are stopped. Depending on tolerances the actual stop position 18 deviates from the target position 16. Such a deviation occurs due to vibrations. Based on the stop position 18, which is determined over the hall sensors 13 by the detection device 14 or the signal-processing arrangement 8, a tolerance range 19 is determined by the signal-processing arrangement 8. That means that an absolute lower margin 20 and an absolute upper margin 21 are determined by the signal-processing arrangement 8, in particular by subtracting or adding a value from or to the actual stop position 18. In particular as long as a reference point 22, which is created in this embodiment by a leading edge of the motor vehicle actuator part 2, is located within the tolerance range 19, thus within the margins 20, 21, the signal-processing arrangement 8 prevents an operating of the electromotor 4 for the case that the operator selects the first target position 16 again with the aid of the operating device 10. Only in the case, in which the reference point 22 has been moved out of the tolerance range 19 in particular due to vibrations, which means is not located in the tolerance range 19, a corresponding controlling of the operating device 10 by the operator causes that the driving motor 4 is controlled in such a way that the motor vehicle actuator part 2 is again adjusted in the direction of the first target position 16. After the adjusting process has taken place the actual stop position is again detected and based on it a tolerance range is calculated with usually deviating absolute margins.

Besides the first target position 16 a further second target position 23 and a third target position 24, a so-called anti-hum-position can be approached by the motor vehicle actuator part 2. The end positions 5, 6 are preferably realized by hard end stops, which is often not possible at sunroofs.

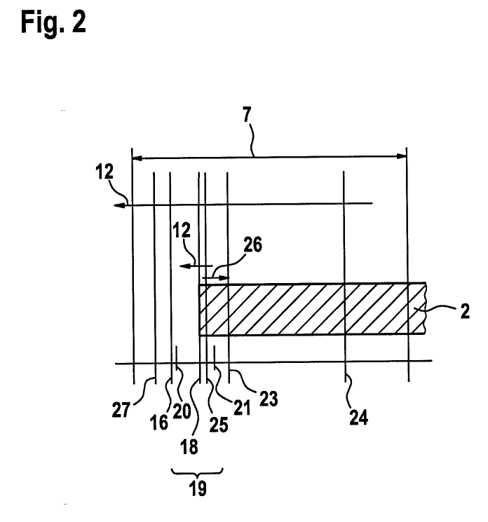

In FIG. 2 the illustration of the operating device 10 of the signal-processing arrangement 8, the motor excitation circuit 9 and the driving motor 4 have been waived due to clarity reasons. Those components can for example be construed as they are explained in FIG. 1.

In the embodiment according to FIG. 2 a nominal position 25 is assigned to a first target position 16 and a second target position 23. Those two target positions 16, 23 that are stored in a storage are only alternatively effective, depending on the direction the motor vehicle actuator part 2 has to drive from towards the nominal position. If the motor vehicle actuator part 2 is adjusted in direction 12, the first target position 16 is for example effective. If the detection device 14 detects that the first target position 16 has been reached, the motor vehicle actuator part 2 is stopped. The actual stop position 18 is determined and based on that stop position 18 the lower margin 20 and the upper margin 21 of a tolerance range 19 are determined. Only if the motor vehicle actuator part 2 is again located outside this tolerance range 19 the first target position 16 or the nominal position 25 can be again approached actively. It is made clear from the embodiment according to FIG. 2 what advantageous effect the creation of the tolerance range 19 around the actual stop position 18 has. A tolerance range around both target positions 16, 23 would be much bigger and would be disturbing for the operator, because no new approaching of the nominal position 25 or the first or second target position 16, 23 would be possible in a noticeably bigger area.

The second target position 23 is active instead of the target position 16, if the motor vehicle actuator part 2 is adjusted in the direction of the arrow 26.

Besides the two target positions 16, 23 a third target position 24 (anti-hum-position) as well as a fourth target position 27 can be approached.

1. An electromotive drive for a motor vehicle actuator part that can be adjusted in at least one defined target position with a detection device for detecting, whether the motor vehicle actuator part is located in a tolerance range, wherein, the tolerance range can be determined depending on the stop position of the motor vehicle actuator part.

2. The electromotive drive according to claim 1, wherein even after a corresponding default of an operator the target position cannot be approached again as long as the motor vehicle actuator part is located within the tolerance range.

3. The electromotive drive according to claim 1, wherein the target position can be approached automatically if the motor vehicle actuator part has left the tolerance range due to external influences.

4. The electromotive drive according to the target position can be approached according to a corresponding default of an operator, if the motor vehicle actuator part has left the tolerance range.

5. The electromotive drive according to claim 1, wherein the tolerance range can be parameterized.

6. The electromotive drive according to claim 1, wherein the detection device comprises at least one magnet field sensor, in particular a hall sensor, and a magnet ring with a magnetic partition that can be rotated relatively to the magnet field sensor.

7. The electromotive drive according to claim 1, wherein depending on the adjusting direction target positions can be approached that are preferably slightly deviating from each other.

8. The electromotive drive according to claim 1, wherein the motor vehicle actuator part can be adjusted between two end positions.

9. The electromotive drive according to claim 8, wherein the target position is created by an end position or a position that lies between the end positions.

10. The electromotive drive according to claim 1, wherein the motor vehicle actuator part is a vehicle roof part, in particular a sunroof.

11. A procedure for controlling an electromotive drive for a motor vehicle actuator part, with which at least one defined target position of the motor vehicle actuator part is controlled, and at which it is detected, whether the motor vehicle actuator part is located in a tolerance range, wherein the tolerance range is determined depending on the stop position of the motor vehicle actuator part.
